(19) United States
(12) Patent Application Publication
(10) Pub. No.: US 2016/0307147 A1
(43) Pub. Date: Oct. 20, 2016

(54) PRODUCT PLACEMENT MONITORING APPARATUS AND METHOD

(71) Applicant: Wal-Mart Stores, Inc., Bentonville, AR (US)

(72) Inventors: Nicholaus A. Jones, Fayetteville, AR (US); Matthew A. Jones, Bentonville, AR (US); Robert J. Taylor, Rogers, AR (US); Aaron J. Vasgaard, Rogers, AR (US)

(21) Appl. No.: 15/091,446

(22) Filed: Apr. 5, 2016

Related U.S. Application Data
(60) Provisional application No. 62/148,115, filed on Apr. 15, 2015.

(51) Int. Cl. G06Q 10/08; G06K 9/00; G06T 7/00; G06K 9/20; G06K 9/62; G06Q 10/06; G06K 9/46

(52) U.S. Cl. CPC G06Q 10/087; G06Q 10/06311; G06K 9/00201; G06K 9/4661; G06K 9/2027; G06K 9/6215; G06T 7/0044; G06T 2207/10152; G06T 2207/30242

(57) ABSTRACT

Methods and apparatuses are provided for use in monitoring inventory. Some embodiments provide a product inventory evaluation apparatus, comprising: an inventory tracking unit comprising: a transceiver; a control circuit coupled with the transceiver; and a memory coupled to the control circuit and storing computer instructions that when executed by the control circuit cause the control circuit to: receive one or more images of a floor of a shopping facility upon which multiple product support units are positioned and configured to store multiple different products; identify, in each of the one or more images, one or more shadows of at least a portion of one or more product support units; and determine, from the one or more shadows of at least the portion of the one or more product support units, whether a first product is present and stored relative to each of the one or more product support units.

### RELATED APPLICATIONS

This application claims the benefit of U.S. Provisional Application No. 62/148,115, filed Apr. 15, 2015, for Jones et al., entitled PRODUCT PLACEMENT MONITORING APPARATUS AND METHOD, Docket No. 8842-134372-US (547US01), which is incorporated herein by reference in its entirety.

### TECHNICAL FIELD

This invention relates generally to inventory of a shopping facility.

### BACKGROUND

In a shopping environment, it can be important that product inventory be moved through a shopping location or facility. Further, the customer experience at the shopping facility can have significant effects on current sales. Providing a pleasant or improved customer experience can lead to customer satisfaction and repeat returns to the shopping location.

There are many ways to improve customer experience. For example, increasing sales items can let the customer save money. The shopping facility layout can affect customer experience based in part on finding products of interest and/or congestion within the shopping facility. Accordingly, it can be advantageous to improve the customers' shopping experience.

### BRIEF DESCRIPTION OF THE DRAWINGS

Disclosed herein are embodiments of apparatuses and methods pertaining to identifying products in customer accessible areas of a shopping facility in need of attention by a shopping facility associate or colleagues. This description includes drawings, wherein:

FIG. 1 illustrates a simplified block diagram of an exemplary shopping facility management system, in accordance with some embodiments;

FIG. 2 shows a simplified block diagram of an exemplary inventory tracking unit, in accordance with some embodiments;

FIG. 3 shows a simplified block diagram of side view of an exemplary product support unit having multiple shelves, in accordance with some embodiments;

FIG. 4 shows an overhead view of a simplified exemplary shadow, in accordance with some embodiments, of a product support unit and products supported thereon, such as the product support unit depicted in FIG. 3;

FIG. 5 illustrates a simplified block diagram of side view of an exemplary product support unit having multiple shelves with one or more lights of a lighting network positioned on and/or adjacent one or more of the shelves and/or the product support unit, in accordance with some embodiments;

FIG. 6 shows a simplified flow diagram of an exemplary process of evaluating product inventory, in accordance with some embodiments;

FIG. 7 depicts a simplified block diagram of an inventory evaluation system, in accordance with some embodiments;

FIGS. 8A-C illustrate a simplified flow diagram of an exemplary processes of capturing image(s) and evaluating the images in tracking and/or evaluating inventory at a shopping facility, in accordance with some embodiments;

FIG. 9 illustrates a simplified flow diagram of a process of capturing one or more images of a shadow or shadows, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems, apparatuses, processes and methods are provided herein that allow for accurate monitoring and identification of areas of a shopping facility that are in need of attention or where one or more actions are needed by one or more shopping facility workers (e.g., associates, colleagues, etc.). The one or more actions can include, for example, auditing a product to confirm stock levels, performing a “pick” of the product to move the product from a back storage area to the sales floor of the shopping facility, restocking products onto a shelf, moving an incorrectly placed product, other such actions, or combinations of such actions. The accurate knowledge of quantities of products and/or their placement can be critical to the effective sales of such products. For example, out of stocks and overstock management can be two of the largest contributors to lost sales and customer and shopping facility worker frustrations. Some systems monitor product stocks and manage product stocks through location systems that track and/or maintain records of where products are placed within the shopping facilities (e.g., in the backroom and on the sales floor). The product placement tracking provided by some present embodiments enhances the accuracy in managing product stocks and overstocks. Further, the enhanced accuracy reduces the worker hours spent in auditing the products and their locations.

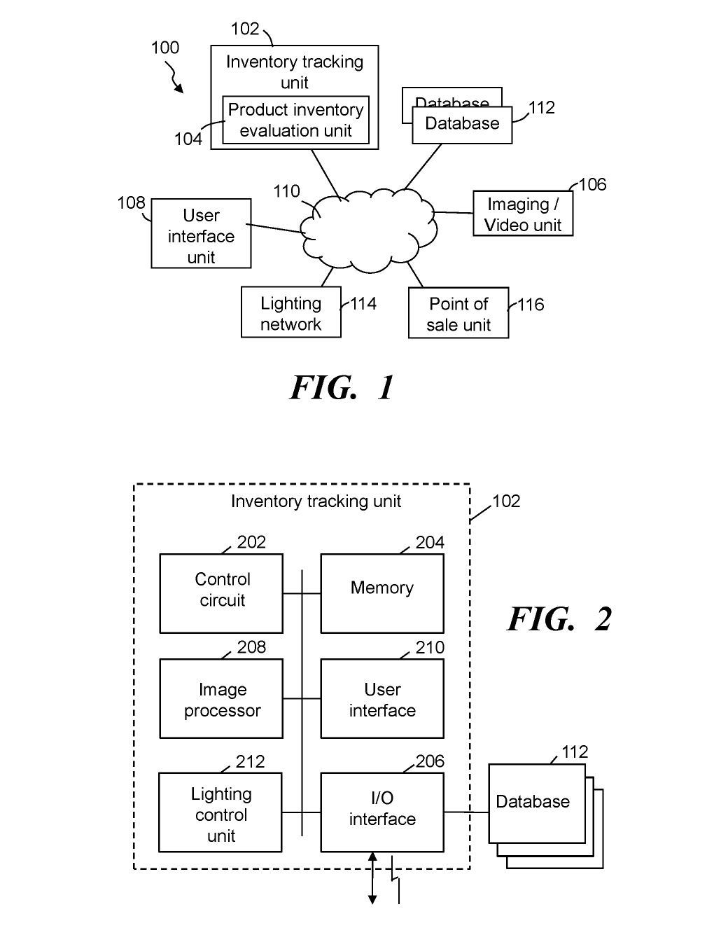

FIG. 1 illustrates a simplified block diagram of an exemplary shopping facility management system 100, implemented in whole or in part at a shopping facility, and that in part is configured to evaluate product placement, in accordance with some embodiments. The evaluation of product placement can include evaluating product quantities, confirm product placement, determine shelf occupancy or fullness, determine available shelf space, and other such product monitoring and/or tracking. Generally, the management system 100 includes a central computer system 102 (sometimes referred to as an inventory tracking or monitoring unit); one or more image and/or video capturing units 106; one or more user interface units 108; at least one distributed communication network 110; one or more database 112; one or more lights and/or lighting networks 114; and one or more point of sales units 116. In some embodiments, the inventory tracking unit includes one or more product inventory evaluation units 104 that is configured to perform some or all of the inventory and/or product evaluation. It is understood that more or fewer of such components may be included in different embodiments of the system 100.

The shopping facility management system 100 may be utilized with a single shopping facility, while in other implementations, the shopping facility management system may extend across multiple shopping facility locations. For simplicity, the embodiments below are described with respect to a single shopping facility. It will be appreciated by those skilled in the art that some embodiments can be applicable to multiple shopping facilities and/or the management of inventory at one or more shopping facilities and/or distribution centers. Further, the shopping facility management system may be operated local at a shopping facility location or remote from the shopping facility location.

By one approach the inventory tracking unit is a computer based device and includes at least one control circuit, at least one memory, and at least one wired and/or wireless network interface. Such a control circuit can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here. This control circuit is configured (for example, by using corresponding programming stored in the memory as will be well understood by those skilled in the art) to carry out one or more of the steps, actions, and/or functions described herein. Further, in some embodiments, the inventory tracking unit or central computer system is implemented local at a shopping facility, while in other embodiments it may be partially or entirely implemented remote from the shopping facility, such as through distributed network and/or cloud based computing.

The inventory tracking unit 102 receives, monitors and tracks product inventory information. The product inventory information can include one or more of product quantity or count information, product location information, product pricing information, product shipment information, and other such information. The one or more image capturing units 106 are configured to capture pictures, video and/or other such images that can be communicated to the inventory tracking unit 102 and/or product inventory evaluation unit 104 to be evaluated in tracking and monitoring inventory and/or shelf space. In some embodiments, one or more image capturing units are incorporated into one or more user interface units 108 that are in communication with the inventory tracking unit. The communication networks 110 can include wired, wireless or combination of wired and wireless communication networks.

In some embodiments, the inventory tracking unit is in communication with and/or provides a least some control over the lighting network 114. Through commands, the inventory tracking unit can in part control lighting while one or more images and/or video are captured by the one or more image capturing units. The one or more point of sales units 116 are configured to allow products to be purchased and/or returned. The inventory tracking unit may utilize information from the point of sales units in further tracking inventory.

As introduced above, the one or more image capturing units 106 are configured to capture images that can be utilized by the inventory tracking unit 102 in determining, confirming, and/or tracking inventory. In some embodiments, one or more of the image capturing units can include one or more fixed cameras that are mounted in the shopping facility at known locations and configured to capture images (e.g., pictures, video, etc.). Additionally or alternatively, some implementations include one or more mobile image capturing units 106 and/or image capturing units that are incorporated into mobile devices. For example, in some implementations, the shopping facility management system 100 may include and/or communicate with one or more mobile user interface units (UIU) 108 that are configured to be carried by shopping facility workers. The user interface units may be one or more smart phones, cellular phones, tablets, or other such devices that include one or more cameras that can be activated to capture relevant images and provide relevant images to the inventory tracking unit 102, and other such devices.

In some instances, one or more of the image capturing units can be configured to capture images bases at least on light that is visible to humans (e.g., within about 400-700 nm wavelength spectrum). Additionally or alternatively, one or more image capturing units may be configured to capture images based on wavelengths outside of light that is visible to humans, such as infrared, ultraviolet, other such wavelengths bands, or combinations of such wavelength bands.

FIG. 2 shows a simplified block diagram of an exemplary inventory tracking unit 102, in accordance with some embodiments. The inventory tracking unit includes at least one control circuit 202, at least one memory 204, and one or more input/output (I/O) interfaces or devices 206. Typically, the inventory tracking unit includes one or more image and/or video processor or processing units 208, and/or the control circuit 202 is configured to include and/or perform image and/or video processing. Further, some embodiments include a user interface 210 to allow a user to interact with the inventory tracking unit. A lighting control unit 212 may also be included in some implementations.

The control circuit 202 typically comprises one or more processors and/or microprocessors. Generally, the memory 204 stores the operational code or set of instructions that is executed by the control circuit 202 and/or processor to implement the functionality of the inventory tracking unit 102. In some embodiments, the memory 204 may also store some or all of particular data that may be needed to perform evaluations, control lighting, make the determinations, and other such functions as described herein. Such data may be pre-stored in the memory or be received, for example, from a remote system, cloud based system, user interface unit, or other sources, or combinations of such sources. It is understood that the control circuit and/or processor may be implemented as one or more processor devices as are well known in the art. Similarly, the memory 204 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 204 is shown as internal to the location controller; however, the memory 204 can be internal, external or a combination of internal and external memory. Additionally, the inventory tracking unit 102 further includes a power supply (not shown) and/or it may receive power from an external source.

The control circuit 202 and the memory 204 may be integrated together, such as in a microcontroller, application specification integrated circuit, field programmable gate array or other such device, or may be separate devices coupled together. The I/O interface 206 allows wired and/or wireless communication coupling of the location controller to external components, such as the databases 112, image capturing units 106, lighting network 114, point of sale unit 116, and other such components. Accordingly, the I/O interface 206 may include any known wired and/or wireless interfacing device, circuit and/or connecting device. Typically, the I/O interface includes one or more wired and/or wireless transceivers, receivers, and/or transmitters. In some embodiments, a user interface 210 is included in and/or coupled with the inventory tracking unit 102, which may be used for user input and/or output display. For example, the user interface 210 may include any known input devices, such one or more buttons, knobs, selectors, switches, keys, touch input surfaces and/or displays, etc. Additionally, the user interface may include one or more output display devices, such as lights, visual indicators, display screens, etc. to convey information to a user, such as status information, location information, mapping information, product location information, product information, video content, operating status information, notifications, errors, conditions and/or other such information. While FIG. 2 illustrates the various components being coupled together via a bus, it is understood that the various components may actually be coupled to the control circuit 202 and/or one or more other components directly.

In part, the inventory tracking unit 102 is configured to receive images (e.g., pictures, video, etc.), and evaluate those images in determining and/or confirming product inventory and/or product placement. Accordingly, in some embodiments, the inventory tracking unit and/or the product inventory evaluation unit typically includes one or more image processors 208 and/or video processors. The image processor 208 or processors are configured to process images (e.g., pictures, video, etc.) as at least part of information in evaluating product inventory and monitoring product placement within the shopping facility. Further, in some embodiments the inventory tracking unit may include one or more lighting control units 212 that allow the inventory tracking unit to control one or more lights, and typically a network of lights while images are being captured by the one or more image capturing units.

In many embodiments, the image capturing units capture images of various parts of the floor at the shopping facility. These images of the floor are analyzed, such as through the image processor 208. Further, the analysis, in many implementations include identifying one or more shadows from one or more images and/or video of a product support unit or structure, or part of a product support unit. These shadows can be evaluated in identifying, tracking and/or determining inventory quantity and/or placement.

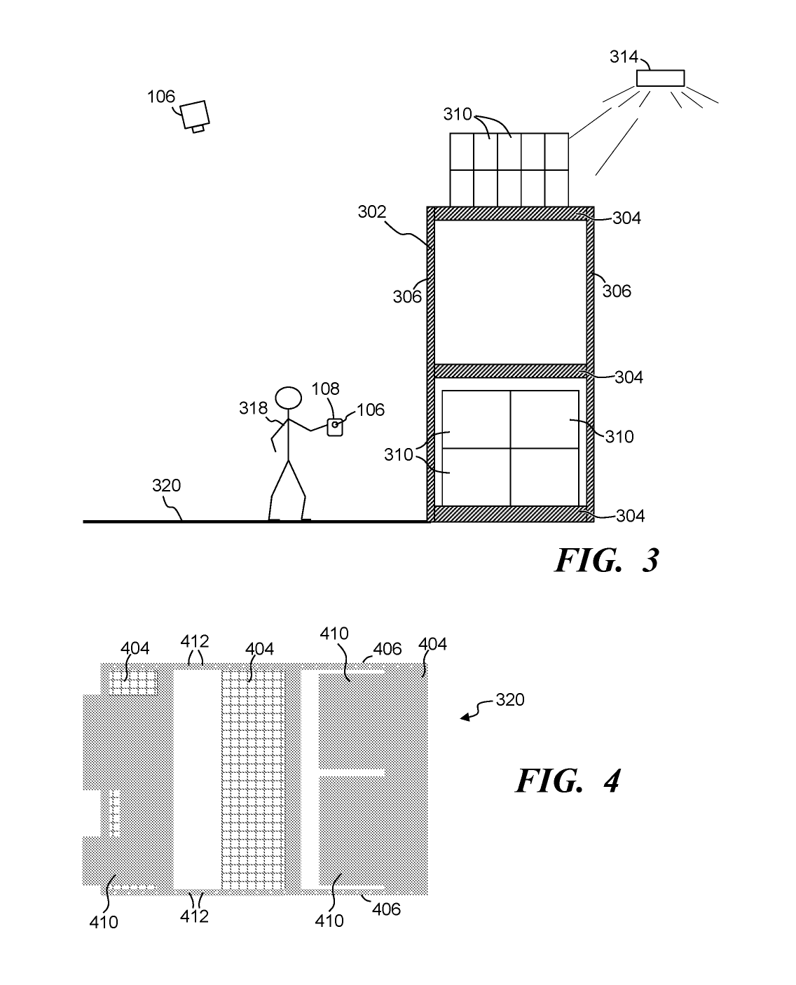

FIG. 3 shows a simplified block diagram of side view of an exemplary product support unit 302 having multiple shelves 304, in accordance with some embodiments. The product support unit can be a rack, a shelf, a bin, a modular, a case, a product storage unit, and substantially any product support structure. The shelves are supported by a frame of the product support unit that includes uprights or vertical supports 306 and typically lateral supports (not illustrated) that cooperatively support the shelves. The shelves are typically configured to support one or more items of one or more products 310. FIG. 3 further illustrates a fixed image capturing unit 106, and a mobile image capturing unit 106, which may be part of a user interface unit 108 (e.g., user interface unit carried by a worker 318). Typically, multiple product support units 302 are positioned within a shopping facility, such as in a back stock area, on the sales floor, and/or in other areas of the shopping facility. It is noted that embodiments described herein are generally described with reference shelves and/or racks of shelves upon which products are placed; however, it will be appreciated by those skilled in the art that the descriptions are not limited to shelves and racks, but can be applied to bins, modulars, cases, and substantially any product support structure at a shopping facility that support and/or hold products.

One or more light sources 314 of the lighting network 114 are further distributed throughout the shopping facility and/or strategically positioned within the shopping facility relative to one or more product support units. The light or lights can emit light that impinges upon the product support units 302 and product 310 supported by the product support units causing one or more shadows 320 on the floor of the shopping facility. In some embodiments, the lights 314 are coupled with a lighting network and/or lighting controller. The inventory tracking unit and/or the product inventory evaluating unit 104, in some implementations, is configured to control turning on and off the lights of the lighting network to obtain desired shadows 320 for accurate evaluation.

FIG. 4 shows an overhead view of a simplified exemplary shadow 320, in accordance with some embodiments, of a product support unit 302 and products supported on the product support unit, such as the product support unit depicted in FIG. 3. Referring to FIGS. 3 and 4, in this example, the shadow 320 includes vertical support shadows 406 of the vertical supports 306 of the product support unit 302, shelf shadows 404 of the shelves 304, and product shadows 410 of the products 310 supported by the shelves. In some embodiments, the shelves 304 are formed of a grating or otherwise can include one or more holes, slits or the like. As such, the shelf shadows 404 where products are missing may include the shadow of the grating or otherwise include a lack of a shadow corresponding to the holes, slots or the like. As described herein, the evaluation of the shadows can include identifying the shadow of the grating or the like in identifying and/or confirming that a portion of a shelf or an entire shelf is empty of products.

In the examples depicted in FIGS. 3 and 4, products have been placed on each of the bottom shelf and the top shelf. Similarly, the shadow 320 includes product shadows 410 caused by the products on the bottom shelf as well as product shadows 410 causes by products on the top shelf. Further, the middle shelf shadow shows the shadow of a grating consistent with the lack of a product on the middle shelf as illustrated in FIG. 3. As also illustrated in FIG. 4, there are portions of the top shelf shadow where the grating shadow of the top shelf is visible and corresponding to areas the top shelf does not include a product. In some implementations, the vertical supports 306 and/or shelf supports may include notches, holes, or the like. These notches may, in some applications, allow the vertical placement of the shelves to be adjusted. In other implementations, the notches may be included to aid in the evaluation of images of the shadows. Accordingly, in some instances, the vertical support shadows 406 may also show the notches 412 from the lack of shadow resulting from light passing through one or more of the notches

One or more image capturing units 106 can be activated to capture images of the flooring of the shopping facility and including the shadows 320 caused by the product support units 302. The images of the shadows can be evaluated to determine whether products are present on the shelves. In some instances, multiple images can be cooperated and/or partially cooperated to generate a composite image of a full shelf shadow and/or a full product support unit shadow. The composite shadow image can then be evaluated. For example, reference points and/or other references may be identified in images that can be used to align different images to generate the composite image of shadow.

As described above and further below, one or more lights may be cooperated with a lighting network that can be controlled through the inventory tracking unit, one or more user interface units, or other such lighting control. Some embodiments control the lights in attempts create greater contrast of the shadow relative to surrounding flooring, and to capture better and/or more clear images of the shadows.

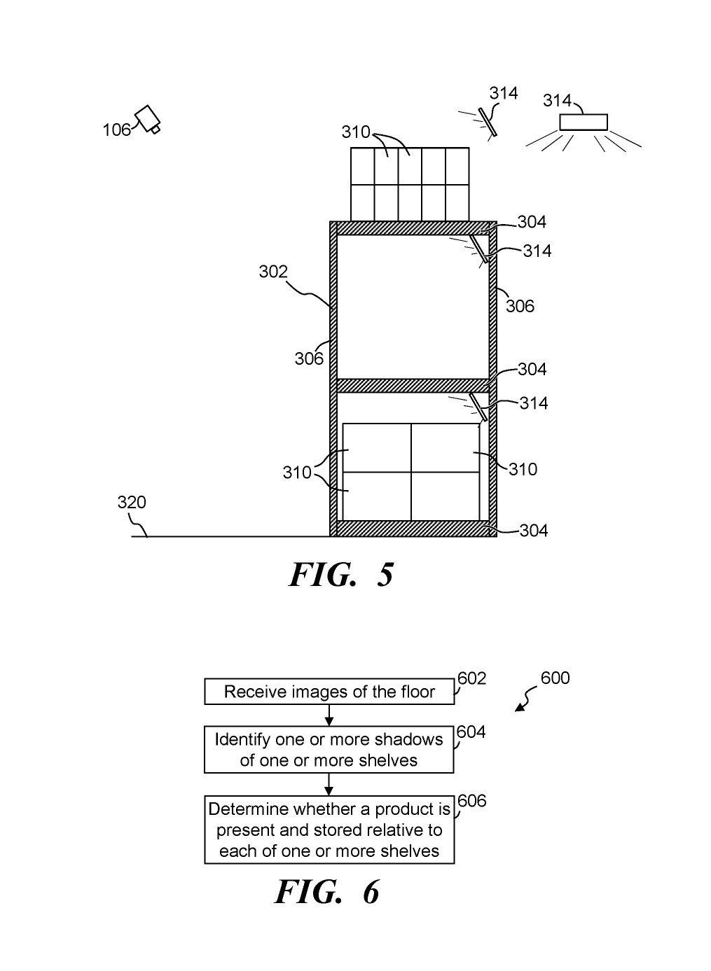

FIG. 5 illustrates a simplified block diagram of side view of an exemplary product support unit 302 having multiple shelves 304 with one or more light sources 314 of a lighting network positioned on and/or adjacent one or more of the shelves 304 and/or the product support unit, in accordance with some embodiments. In the example, illustrated in FIG. 5, a light 314 is positioned above each of the shelves, such that the lights are separated by a distance and in some instances a shelf. More than one light may be positioned along a length of a shelf. By controlling which one or more of the lights 314 are turned on and off, shadows of respective shelves may be more readily distinguished in the image of the shadow captured, and thus, may allow for more accurate determination of product placement on the shelf and/or absence of one or more products on a shelf In some embodiments, the different lights may be configured to generate different levels or intensities of light.

Additionally or alternatively, in some instances, one or more lights may emit light in a non-visible spectrum allowing the control of the lights of the light network without adversely effecting ambient and/or visible light, and/or without having to turn off lights emitting light in the visible spectrum (e.g., ambient lights). The image capturing unit or units 106 can be configured to capture images in the non-visible spectrums, for example, through the use of filtering, selection of photosensitive diodes, etc. In some implementations, one or more additional ambient light sources may additionally be included. The ambient light sources may, in some instances, also be part of the lighting network and be controllable during the image capturing. The inventory tracking unit typically communicates with the lighting network and activates and/or deactivates one or more of the lights 314 of the lighting network. In some instances, the image capturing unit 106 and/or user interface unit may communicate with the inventory tracking unit indicating images are ready to be captured such that the inventory tracking unit can activate or deactivate one or more lights. Additionally or alternatively, the image capturing unit and/or user interface unit may communicate directly with the lighting network. A location of the image capturing unit and/or user interface unit can be used to determine which lights are to be activated and/or deactivated. Similarly, the inventory tracking unit may issue commands to the image capture unit to control when the images are captured, such as after the inventory tracking unit has activated and/or deactivated desired lights.

FIG. 6 shows a simplified flow diagram of an exemplary process 600 of evaluating product inventory, in accordance with some embodiments. In step 602, one or more images of a floor of the shopping facility are received. Again, multiple product support units (e.g., racks, shelves, bins and other such product support units) are positioned on the floor and each is configured to support and/or store one or more different products. In step 604, one or more shadows of at least a portion of one or more product support units and/or one or more shelves of the multiple product support units are identified in each of the one or more images. In step 606, it is determined, from the one or more shadows of at least the one or more product support units and/or one or more shelves, whether a first product is present and stored relative to each of the one or more product support units and/or shelves. The determination can include identifying and/or confirming the presence or absence of at one or more of at least one product relative to one or more shelves and/or portions of a shelf. For example, in some instances a lack of a shadow can be detected relative to a first portion of a first shadow corresponding to a first shelf, and based on the detected lack of the shadow, it can be determined that a first portion of the first shelf is empty.

Additionally or alternatively, in step 606, the confirmation can include determining an estimated quantity of one or more products stored relative to each of the one or more shelves from the shadows of the one or more shelves. The confirmation and/or determined quantity of the one or more products can be used for various purposes, including but not limited to confirming product placement and/or inventory count, determining whether an audit of one or more products should be recommended and/or implemented, locating a product of interest, confirming a location of a product of interest, other such purposes, and combinations of two or more of such purposes. For example, the inventory system may designate that a first quantity of a product is placed at one or more locations on one or more shelves of a product support unit. By analyzing a shadow of the product support unit or portion of the product support unit, the system can determine whether the first product is at the expected locations on the one or more shelves. Further, in some implementations, the system can confirm whether the quantity of the first product at the one or more locations on the one or more shelves is at the expected quantities.

Some embodiments, in confirming the presence or absence of products evaluate a first shadow of the one or more shadows of one or more of the multiple shelves, and determine, as a function of the evaluation of the first shadow, a location of the first shadow within the shopping facility. Each of one or more shelves causing the first shadow can be identified based on the determined location of the first shadow. An expected inventory quantity value of a product that is expected to be supported by the identified one or more shelves can be obtained, for example as specified in an inventory database. It can be determined whether there is a difference between the expected inventory quantity value of the product expected to be supported by the identified one or more shelves and a quantity of the first product, determined from the one or more shadows, that are stored relative to each of the one or more shelves.

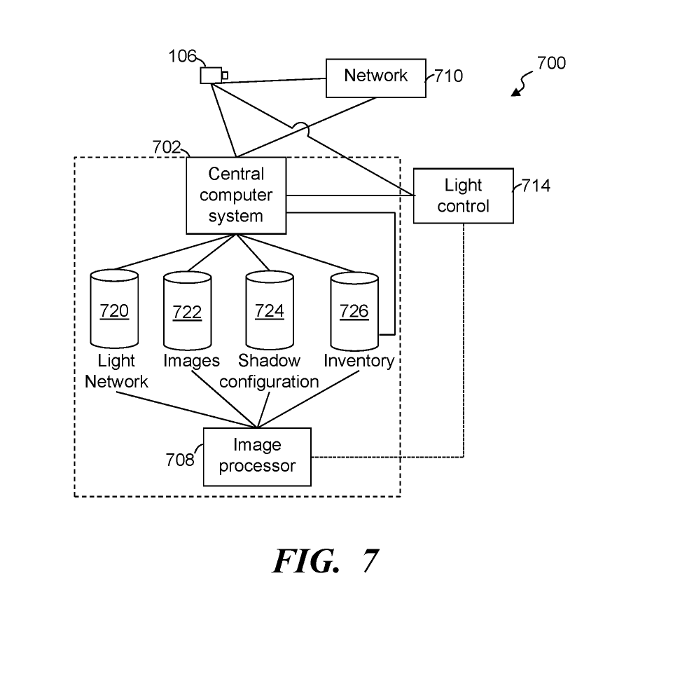

FIG. 7 depicts a simplified block diagram of an inventory evaluation system 700, in accordance with some embodiments, and which is typically part of the management system 100. The inventory evaluation system includes a central computer system 702, which includes and/or is coupled with one or more image processors 708, and one or more databases, such as a lighting network database 720, pictures database 722, shadow configuration database 724, and an inventory database 726; one or more image capturing units 106; and a communication network 710. Some embodiments further include one or more lighting controls 714 and/or lighting network.

The one or more image capturing units 106 are positioned relative to one or more product support units, racks, shelves, bins or the like. Further, the image capturing units, in some embodiments, are in communication with the central computer system 702 via the communication network and activated by the central computer system to capture one or more images and/or video of portions of the floor and/or one or more walls of the shopping facility. The activation by the central computer system may be based on a schedule, based on a task being performed, other such conditions, or combinations thereof. For example, in some instances, the central computer system may issue instructions to a shopping facility worker (or be notified of such instructions being sent to the shopping facility worker). Accordingly, the central computer system is aware of the task the shopping facility worker has been instructed to perform, and typically has knowledge based on knowledge of a mapping of the shopping facility and/or a shopping facility layout of where the task is to be performed. Accordingly, the central computer system can activate one or more image capturing units and/or lights of the light network corresponding to the determined location. In other embodiments, the image capturing units may be activated based on a schedule, one or more sensors (e.g., motion sensors), other triggers, or combinations of such activations.

Similarly, in some instances, the image capturing units may have at least some control over one or more lights of the lighting system. For example, an image capturing unit, when ready to capture an image, may be configured to send an instruction to activate and/or deactivate one or more lights. The control of the lights produces a shadow that typically is more readily identified in the images and/or more readily analyzed. Again, the lights can emit lights in non-visible light (e.g., infrared light). Further, the central computer system, with knowledge of the location of the image capturing units and a determined area of interest of the shopping facility (e.g., based on a task being performed, based on determined location, etc.), can identify relevant lighting and control the lights in the relevant area to achieve a desired shadow of a desired product support unit or portion of a product support unit (e.g., specific shelf).

The captured images are received at the central computer system and/or forwarded to the image processor 708. In some embodiments, the image processor utilizes multiple pictures to create a composite image of a shadow or part of a shadow to be evaluated. The evaluation of the shadow can include a consideration of an intensity of the shadow, dimensions of the shadow, knowledge of the location of lighting relative to the product support unit, shelf, etc., and the like.

The databases can be used by the central computer system and/or the image processor in evaluating the images of the shadows. For example, the lighting database 720 provides information regarding what lights are available in the shopping facility and where each light is located. The location information may also include a correlation with one or more product support units or shelves, while in other instances, a mapping of the shopping facility is utilized in combination with the lighting database to identify relevant lights that should be controlled when attempting to acquire images of shadows of specific product support units and/or shelves. The image database maintains pictures taken of the shadows, of product support units and/or shelves. In some embodiments, the image database maintains one or more reference shadow images of one or more shelves and/or one or more product support units. For example, one or more reference images of a first product support unit shadow can be acquired and stored of the shadow of the first product support unit while one or more of the shelves of the first product support unit are empty, and a subsequent reference image of the first product support unit shadow can be acquired and stored of the shadow of the first product support unit while one or more shelves are full of one or more products. Images may also be maintained of one or more shelf and/or product support unit shadows as captured in response to evaluating inventory.

The shadow configuration database 724 maintains information regarding shadows of product support units, shelves, bins and the like. In some embodiments, the shadow configuration database stores parameters of the shadows of the shelves and/or product support units that are expected to be evaluated. For example, the shadow configuration for a shelf may define dimensions of the shadow of the shelf; location and/or distances of the shadow of the shelf within a shadow of a product support unit; whether the shelf shadow has a grid or grating shadow; shadow intensity, which can be dependent on and/or is based on the lighting network and which lights are active; intensity between a support structure of the product support unit, and a product; and the like. Accordingly, the shadow configurations in some implementations define references of the shadows of product support units, shelves, racks, bins, etc. and what those shadows should look like. Similarly, the references may define what the shadow should look like in different levels of fullness (e.g., when supporting products and not supporting products). Further, in some implementations, the shadow configuration database maintains reference information of what an expected shadow should include, dimensions, and the like, including such parameters when there are products on a shelf verse when the shelf is empty. Similarly, reference shadows of products and/or groupings of products (e.g., a pallet of a product).

The inventory database 726 may be specific to the shadow evaluation or may be a general inventory database of the shopping facility. Further, the inventory database typically stores information about a current state of inventory of one or more products. Additionally, in some embodiments, the inventory database maintains inventory information relative to one or more product support units and/or one or more shelves, bins, or the like. As such, when evaluating an image of a shadow, the inventory database can be accessed to obtain information about what the inventory system has recorded of whether one or more products should be on a shelf, and typically a quantity of product that should be on the shelf.

In some embodiments, the image processor 708 accesses one or more of the databases in processing the images of shadows. In processing the images, the image processor typically identifies a location of the image, which may be received from the image capturing unit, be determined based on identifying an image capturing unit supplying the image, based on an evaluation of the image (e.g., identifying a product support unit and/or product support unit number or other identifier in the image, detecting a reference point (e.g., on floor, based on a structure of a product support unit, spacing between product support units, etc.)), based on a task being performed, other such factors, or combinations of such factors.

The image processor further identifies a shadow within an image or composite image. The shadow is evaluated to determine whether one or more products are placed on one or more shelves and/or determine quantities of products on the shelf or shelves. The shadow evaluation can include evaluating the shadow relative to the shadow configuration corresponding to the shadow. The image processor can further take into consideration where the lights are located relative to where the picture was taken, and which lights were on or off when the picture was taken. In some embodiments, based on the evaluation of the shadow, the central computer system can determine what inventory levels are on each shelf corresponding to the shadow evaluated. Further, when a discrepancy is detected between what is recorded in the inventory database and what is determined from the analysis of one or more shadows, the central computer system instructs a shopping facility worker to perform an audit of the corresponding product support unit and/or shelf. For example, a difference can be identified between a determined quantity of the first product, determined based on the one or more shadows of the one or more shelves, relative to an expected inventory quantity. Based on this difference, some embodiments may cause a request to be communicated to a shopping facility worker to audit the first product when the difference is greater than a difference threshold. Some embodiments further include a feedback loop to provide updates back to the inventory database when discrepancies are identified between what the inventory database indicates and a determined and/or actual inventory.

Some embodiments additionally include feedback for light control. For example, it may be determined based on image processing that the control of the lighting should be changed to achieve better images. For example, images may be detected that do not include useful information, the lighting was too bright or not enough, etc. The lighting control and/or feedback loop provides greater control over the lighting

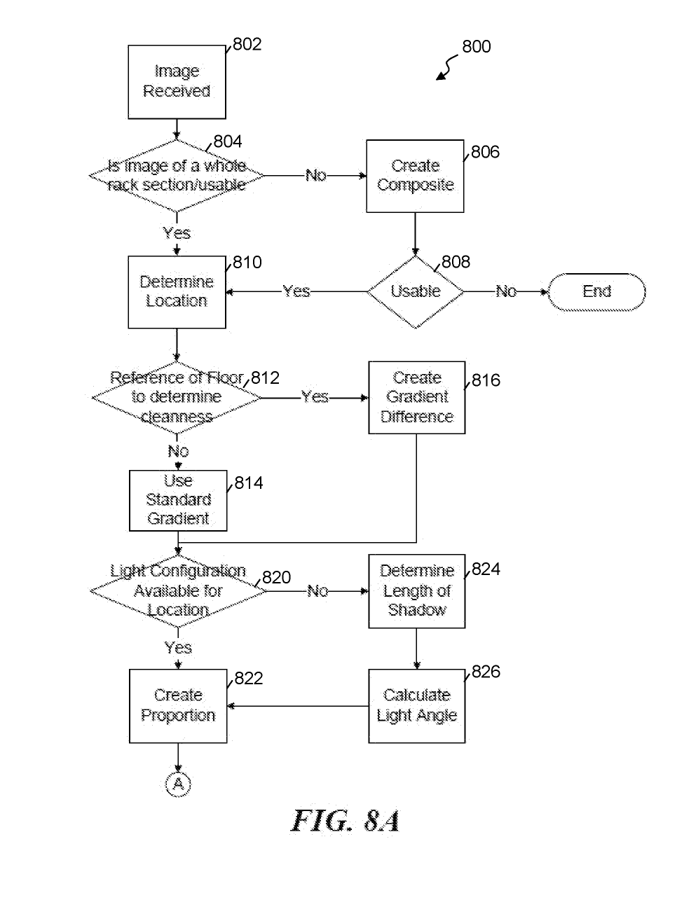

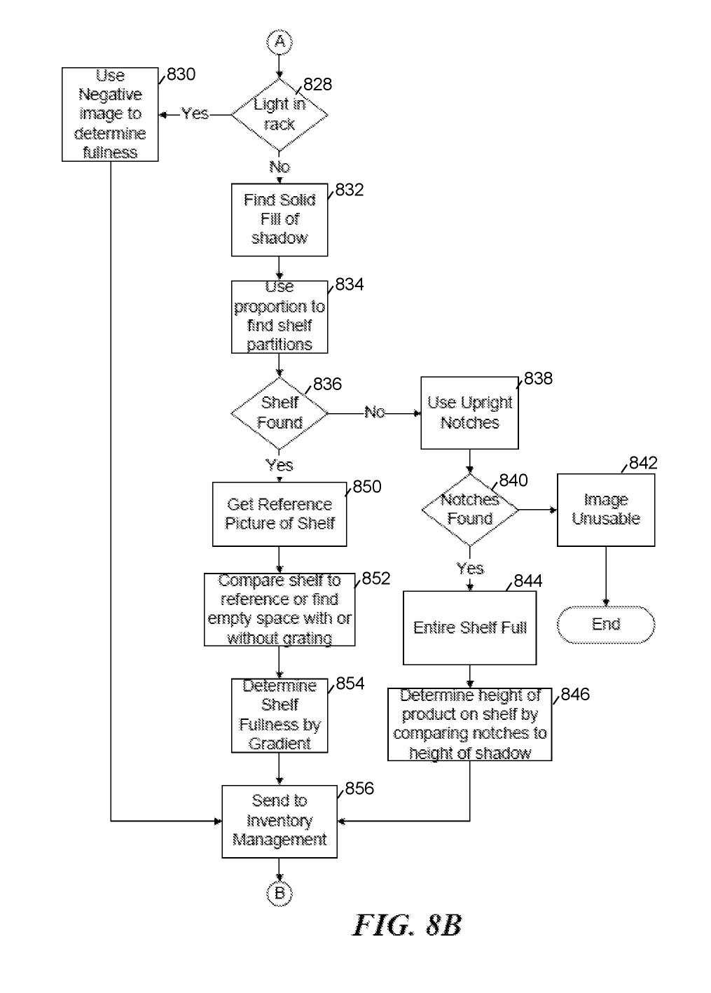

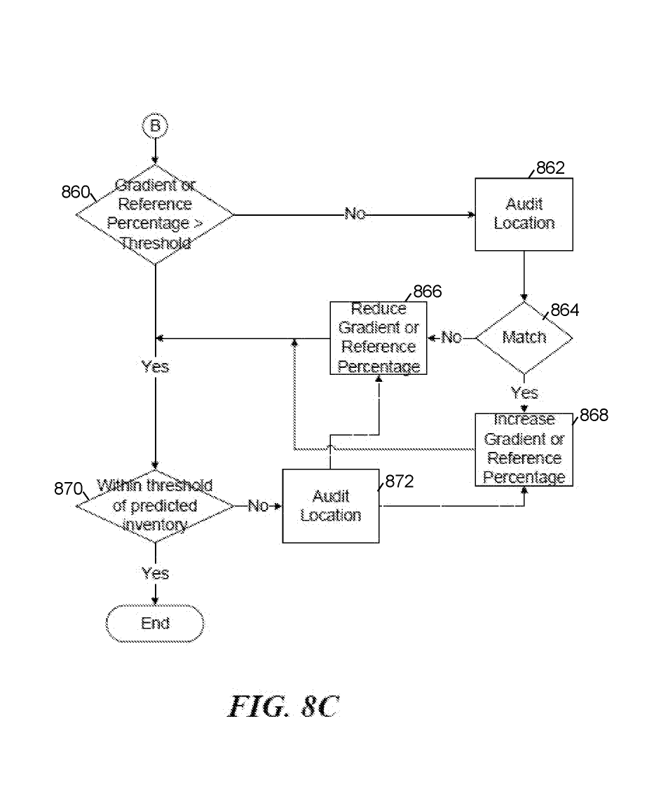

FIGS. 8A-C illustrate a simplified flow diagram of an exemplary processes 800 of capturing image(s) and evaluating the images in tracking and/or evaluating inventory at a shopping facility, in accordance with some embodiments. In step 802, one or more images are received. In step 804, the image is analyzed to determine whether the image includes a full shadow of a product support unit or a sufficient amount of the product support unit that includes a portion of interest (e.g., such as including a specific shelf, a portion of a shelf expected to be supporting a particular product, or the like).

In step 806, when the image only includes a partial shadow, a composite image may be generated combining at least portions of multiple images when sufficient numbers of other images are available to create an image with a full shadow or sufficient amount of shadow that can be effectively analyzed. In step 808, it is determined whether the composite image and/or the initial image is usable. For example, when a composite cannot be generated, an insufficient composite can only be generated, the initial image is actually unusable (e.g., a shadow cannot accurately be detected), or the like, the image and/or composite image is not used. In some instances the initial picture may be stored for later use in generating a subsequent composite image.

In step 810, a location of the detected shadow in the image is determined. The location may be determined, for example, based on a task that was being performed by a shopping facility worker, based on a known location of a fixed camera, based on a reference point within the image, GPS data, Wi-Fi signaling and/or triangulation, and the like. In step 812, it is determined whether a floor reference image, reference gradient or the like is available for the determined location. The reference gradient can define in part and/or be used to determine how clean the floor is when the picture was taken. When a reference gradient is not available, some embodiments access, in step 814, a standard or reference gradient. Alternatively, when a reference gradient is available, the process advances to step 816, a gradient difference or differential is determined as a function of a reference gradient corresponding to the location of the shadow relative to the image of the floor including the shadow being evaluated. For example, in steps 814 and 816 a comparison of the reference gradient and the floor in the image with the shadow is performed to determine a differential between the floor without the shadow and the shadow within the image. Some embodiments determine a gradient offset between a first image of the floor of the one or more images and a reference image of the floor at a location where the first image is captured. Accordingly, the control circuit in identifying the one or more shadows of one or more shelves can be further configured, in some embodiments, to apply the gradient offset in distinguishing between the one or more shadows on the floor and the floor without a shadow.

In step 820, it is determined whether a light configuration and/or placement is known at the determined location of the shadow. In some instances, the light configuration can include a known location of one or more lights relative to a given product support unit. When a light configuration is known, step 822 is entered where a shadow proportion of the shadow to an actual product support unit size is determined based on the known configuration. When a light configuration is not known or cannot be identified, step 824 is entered where a length of a shadow or a length of a relevant portion of a shadow (e.g., length between two shelves, length between a set of notches, other such portions, or combinations of two or more of such portions) is determined. Again, the length may be based on a complete image of a shadow of the product support unit, the composite shadow, or a relevant portion of the product support unit shadow. In step 826, an angle of the light is determined as a function of the determined length, and the determined angle is used to create the shadow proportion in step 822 (e.g., the shadow is five feet long, and the product support unit is twelve feet long, providing a shadow proportion of 5/12).

In step 828, it is determined whether there are one or more lights proximate to and/or within the product support unit that can be controlled. Again, when there are lights within the product support unit, rack and/or bins, those lights can typically generate greater difference with more defined and clearer shadows of one or more specific areas of a product support unit than typically available with just ambient light. As such, the shadows are often readily identifiable, and correspond to a negative image or picture of the products on the corresponding shelves. In those instances, where lights are proximate to and/or within the product support unit, the process advances to step 830 where one or more negative images are directly used and evaluated to identify a determined fullness of the corresponding product support unit, shelf, bin, etc. (e.g., shadow corresponds to a product).

In step 832, a solid fill is identified within the image of the shadow in attempt to identify the shelf partitions of the product support unit and accordingly shelf differences. For example, blocks can be defined across areas where shelf partitions are predicted in reference with known shelf parameters (e.g., separations between shelves, length and width of shelf, determined shadow proportion, etc.). In some instances, with a known shelf cross-beam height and/or shelf width, and a proportional sized shadow to the cross-beam height and/or shelf width extends across an entire length of the shadow, then in step 834 this portion of the shadow is identified as the shelf partition, and can be distinguished from products that are on the shelf. In step 836, it is determined whether a shelf partition is identified.

When a shelf cannot be identified in step 836, the process advances to step 838 and the image of the shadow is evaluated to determine whether notches, holes and/or reference holes within the uprights or vertical supports of the product support unit can be identify. In step 840 it is determined whether notches or other identifiers are detected. When notches cannot be accurately identified the image and/or composite is deemed unusable in step 842 (e.g., cannot differential between parts of the shadow).

In some embodiments, when sufficient notches can be found, the process advances to step 844 to designate, due to the lack of being able to identify the shelf cross-beam and the detection of the notches, that the shelf is full with one or more products. In step 846, the height of the product on the shelf is determined. In some implementations, the height of the shadow of the product can be evaluated relative to the height of the notches detectable in the shadow of the vertical supports and/or separation between two notches in a vertical support. Again, the separation between notches is known. As such, the height of the product can be identified relative to the determined distance between notches and the shadow proportion. The height of the product can then be used to determine an amount of product on a shelf, including product on a top shelf that may extends above the vertical supports of the product support unit. For example, in some embodiments, a product support unit height is compared to a determined height of one or more products on a first shelf. Typically, the product support unit height is known or can be calculated based on measurements of the shadow in the one or more images (e.g., known location of a light relative to the product support unit, distance between shelves, distance between notches, etc.). Similarly, the height of the product on a shelf can be calculated (e.g., determined based on a distance between representations, in a shadow, of notches or other such known spaces on a product support unit and/or shelf, or other reference distance, such as a detectable feature applied on the floor or other structure). Based on the comparison of the product support unit height and the determined height of the one or more products a fullness of the first shelf can be determined.

Some embodiments include step 850, where a reference shadow of the product support unit and/or shelf is identified (e.g., a reference shadow of the product support unit and/or shelf while it is empty) and used to compare to the shadow being evaluated in determining what is present and what is missing. Some embodiments additionally or alternatively include step 852 where the shadow is evaluated to determine whether known shadow shapes are detected, such as empty space with or without a shadow of a grating, grid, mesh, etc. that forms the actual shelf upon which the products are placed. Again, in some instances, this may be evaluated relative to a reference shadow.

In step 854, a fullness of the shelf is determined based the determined reference, the amount of empty space, the identified shelf structure, and the like. In some implementations, the determination of the fullness further considers the shadow gradient in distinguishing the shadow from the floor. In step 856, the information is considered in relation to expected inventory (e.g., based on inventor database information) and/or forwarded to an inventory management system.

Some embodiments include step 860, where the gradient or reference percentage is evaluated relative to one or more thresholds. For example, it can be determined how successful the evaluations of the images have been in the past with respect to a particular shading difference and/or particular reference picture, the particular gradient, and/or a reference percentage. When past evaluations have not had success rates greater than the determined threshold, then in step 862, an audit of the location, product support unit, shelf, portion of the shelf, etc. may be requested. This can include notifying a shopping facility worker and requesting that the worker physically evaluate the product support unit, shelf, etc. In step 864, the audit results are received and evaluated to determine whether the evaluation of the shadow is consistent (typically within a margin of error or other threshold) with the audit results. In step 866, the gradient and/or reference percentage used in step 860 is reduced when the difference between the shadow evaluation and the audit exceeds an error threshold. Alternatively, in step 868 the gradient and/or reference percentage is increased when the shadow evaluation and the audit results are consistent. This provides a check to confirm accuracy of evaluation, and the history of previous gradients or reference percentage.

Some embodiments include step 870, where the determined product inventory determined from the shadow evaluation is compared with a predicted product quantity, which is typically based and/or equal to what the inventory system believes should be present on the product support units. Accordingly, when the product quantity determined from the shadow evaluation is more than an inventory difference threshold from an expected inventory total, some embodiments initiate an audit in step 872. The results of the audit may further be evaluated to adjust the gradient and/or reference percentage.

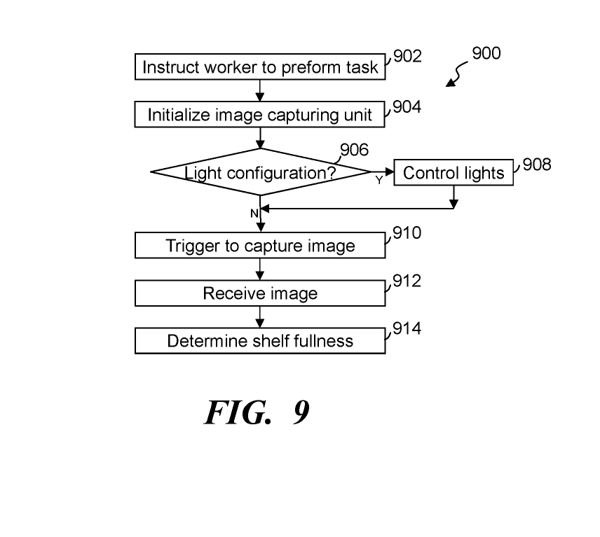

FIG. 9 illustrates a simplified flow diagram of a process 900 of capturing one or more images of a shadow or shadows, in accordance with some embodiments. Some implementations optionally include step 902 that issues an instruction to one or more shopping facility workers to perform a task relative to a product support unit. In step 904, one or more image capturing units are initialized in preparation to capture an image. In step 906, it is determined whether lighting can be controlled relative to the product support unit and/or the shadow of the product support unit attempting to be captured in an image. When lighting can be controlled, step 908 is entered where one or more lights are activated, deactivated, and/or the illumination intensity adjusted.

In step 910, the image capturing unit is instructed or triggered to capture an image. Again, in some instances, the triggering may be depending one or more factors, including whether the task has been performed, whether there is motion proximate the shadow, or the like. In step 912, one or more images of the shadow are received. In step 914, the image of the shadow or a composite of images are evaluated to determine fullness of a shelf or product support unit.

As described above, the image capturing units capture images of shadows on the floor of the shopping facility of product support units, bins or the like. The image capturing units can be activated by a user; activated based on a schedule (e.g., schedule may be based on anticipated times of low movement/activity); triggered when no movement is detected (e.g., no movement for a predefined threshold (e.g., 4 seconds)) and/or triggered when no movement is detected in combination with the schedule; triggered based on an event (e.g., an act is to be performed by a shopping facility worker (e.g., to perform a “picking task”), which may include taking a picture before the task is implemented (e.g., detecting the “picking task” is to be issued, so capture a picture (which may be dependent on activity level at location, such as based on movement sensor) prior to issuing the picking task instruction, then capturing a subsequent picture after it is believed the picking task is completed or at least the product is moved from the back area, and the two pictures are evaluated to identify a difference in the shadow, use difference to confirm accurate product was taken, etc.)); similarly, shadow evaluations may be performed prior to issuing the instruction, such as to confirm the product is available and/or available at sufficient levels prior to issuing the picking task; and the like. Similarly, some embodiments utilize video instead of or in cooperation with images. For example, some embodiments compare video frames to detect a change in the shadow. Similarly, the comparison of frames may be triggered in response to detected movement proximate a location of a shadow, based on a task the worker is to perform, or other such conditions.

Some embodiments further compensate for variations in image capture location when images are captured by a movable image capturing unit (e.g., from a user interface unit). A location of the shadow may be determined using reference points, know where a worker is when the picture is taken based on instructed task; using the shadow itself and confirming a location based on what the shadow is expected to include (e.g., if portion of shelf is expected to be empty, confirming a location when the expected section is confirmed empty, such as detected shadow of grating); determine length of shadow; determine width of shadow; and the like. Further, some embodiments compare of a length of the shadow (corresponding to the product support unit height) to a height shadows of products on the shelf to determine a fullness of a shelf.

In some embodiments, apparatuses and methods are provided that track inventory at a shopping facility. In some embodiments, a product inventory evaluation apparatus, comprises: an inventory tracking unit comprising: a transceiver configured to couple with and receive communications from over a distributed network; a control circuit coupled with the transceiver; and a memory coupled to the control circuit and storing computer instructions that when executed by the control circuit cause the control circuit to: receive one or more images of a floor of a shopping facility upon which multiple product support units are positioned and configured to store multiple different products; identify, in each of the one or more images, one or more shadows of at least a portion of one or more product support units of the multiple product support units; and determine, from the one or more shadows of at least the portion of the one or more product support units, whether a first product is present and stored relative to each of the one or more product support units.

In some embodiments, a method of evaluating inventory, comprises: by a control circuit of an inventory system of a shopping facility: receiving one or more images of a floor of the shopping facility upon which multiple product support units are positioned and configured to store multiple different products; identifying, in each of the one or more images, one or more shadows of at least a portion of one or more product support units of the multiple product support units; and determining, from the one or more shadows of at least the portion of the one or more product support units, whether a first product is present and stored relative to each of the one or more product support units.

Some embodiments provide a product inventory evaluation system, comprising: multiple product support units; at least one image capturing unit; an inventory tracking unit coupled to the at least one image capturing unit and comprising: a transceiver configured to couple with and receive communications from over a distributed network; a control circuit coupled with the transceiver; and a memory coupled to the control circuit and storing computer instructions that when executed by the control circuit cause the control circuit to: receive one or more images of a floor of a shopping facility upon which the multiple product support units are positioned and configured to store multiple different products; identify, in each of the one or more images, one or more shadows of at least a portion of one or more product support units of the multiple product support units; and determine, from the one or more shadows of at least the portion of the one or more product support units, whether a first product is present and stored relative to each of the one or more product support units.

Further, some embodiments provide a product inventory evaluation system, comprising: multiple product support units; at least one image capturing unit; an inventory tracking unit coupled to the at least one image capturing unit and comprising: a transceiver configured to couple with and receive communications from over a distributed network; a control circuit coupled with the transceiver; and a memory coupled to the control circuit and storing computer instructions that when executed by the control circuit cause the control circuit to: receive one or more images of a floor of a shopping facility upon which the multiple product support units are positioned and configured to store multiple different products; determine a gradient offset between a first image of the floor of the one or more images and a reference image of the floor at a location where the first image is captured; apply the gradient offset in distinguishing between one or more shadows on the floor and the floor without a shadow; identify, in each of the one or more images, one or more distinguished shadows of at least a portion of one or more product support units of the multiple product support units; determine, from the one or more shadows of at least the portion of the one or more product support units, whether a first product is present and stored relative to each of the one or more product support units; identify a difference between a determined quantity of the first product, determined based on the one or more shadows of at least the portion of the one or more product support units, relative to an expected inventory quantity; and communicate a request to a shopping facility worker to audit the first product when the difference is greater than a difference threshold.

Some embodiments provide a product inventory evaluation system, comprising: a control circuit of an inventory system of a shopping facility, comprising: means for receiving one or more images of a floor of the shopping facility upon which multiple product support units are positioned and configured to store multiple different products; means for identifying, in each of the one or more images, one or more shadows of at least a portion of one or more product support units of the multiple product support units; and means for determining, from the one or more shadows of at least the portion of the one or more product support units, whether a first product is present and stored relative to each of the one or more product support units.

The described features, structures, or characteristics of the invention may be combined in any suitable manner in one or more embodiments. In the following description, numerous specific details are provided. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention. The embodiments shown in the drawings, if any, and as described above are merely for illustrative purposes and not intended to limit the scope of the invention. Moreover, those skilled in the art will recognize that a wide variety of modifications, alterations, and combinations can be made with respect to the above described embodiments without departing from the scope of the invention as set forth in the claims, and that such modifications, alterations, and combinations are to be viewed as being within the ambit of the inventive concept.

What is claimed is:

1. A product inventory evaluation apparatus, comprising:
an inventory tracking unit comprising:
a transceiver configured to couple with and receive communications from over a distributed network;
a control circuit coupled with the transceiver; and
a memory coupled to the control circuit and storing computer instructions that when executed by the control circuit cause the control circuit to:
receive one or more images of a floor of a shopping facility upon which multiple product support units are positioned and configured to store multiple different products;
identify, in each of the one or more images, one or more shadows of at least a portion of one or more product support units of the multiple product support units; and
determine, from the one or more shadows of at least the portion of the one or more product support units, whether a first product is present and stored relative to each of the one or more product support units.

2. The product inventory evaluation apparatus of claim 1, wherein the control circuit, in determining from the one or more shadows of at least the portion of the one or more product support units whether the first product is present, is further configured to:
detect a lack of a shadow relative to a first portion of a first shadow corresponding to a first shelf; and
determine, based on the detected lack of the shadow, that a first portion of the first shelf is empty.

3. The product inventory evaluation apparatus of claim 2, wherein the control circuit, in detecting the lack of the shadow, identifies a shadow of a grating of the first shelf at the first portion of the first shadow.

4. The product inventory evaluation apparatus of claim 1, wherein the control circuit is further configured to:
cause a first light source, positioned proximate a first shelf of the one or more of a first product support unit causing the one or more shadows, to be turned on and cause a second light source to be turned off, wherein the second light source is positioned proximate to the first shelf and is separated from the first light source by a distance; and
communicate an instruction to activate an image capturing unit to capture a first image of the one or more images while the first light source is on and the second light source is off.

5. The product inventory evaluation apparatus of claim 4, wherein the first light source emits light in a non-visible spectrum, and the control circuit is configured to leave ambient lights on while controlling the first and second light sources.

6. The product inventory evaluation apparatus of claim 1, wherein the control circuit, in determining from the one or more shadows of at least the portion of the one or more product support units whether the first product is present, is further configured to:
compare the one or more shadows in a first image comprising a shadow of at least a first shelf with a reference shadow of at least the first shelf; and
determine a quantity of the first product as a function of a difference between the shadow of the first shelf in the first image and the reference shadow of the first shelf

7. The product inventory evaluation apparatus of claim 1, wherein the control circuit is further configure to:
evaluate a first shadow of the one or more shadows of one or more of the multiple product support units;
determine, as a function of the evaluation of the first shadow, a location of the first shadow within the shopping facility;
identify each of one or more shelves causing the first shadow based on the determined location of the first shadow;
obtain, as specified in an inventory database, an expected inventory quantity value of the first product that is expected to be supported by the identified one or more shelves; and
determine whether there is a difference between the expected inventory quantity value of the first product expected to be supported by the identified one or more shelves and a quantity of the first product, determined from the one or more shadows, that are stored relative to each of the one or more shelves.

8. The product inventory evaluation apparatus of claim 1, wherein the control circuit is further configure to:
determine a gradient offset between a first image of the floor of the one or more images and a reference image of the floor at a location where the first image is captured; and
wherein the control circuit in identifying the one or more shadows of at least the portion of the one or more product support units is further configured to apply the gradient offset in distinguishing between the one or more shadows on the floor and the floor without a shadow.

9. The product inventory evaluation apparatus of claim 1, wherein the control circuit is further configured to:
identify a difference between a determined quantity of the first product, determined based on the one or more shadows of at least the portion of the one or more product support units, relative to an expected inventory quantity; and
communicate a request to a shopping facility worker to audit the first product when the difference is greater than a difference threshold.

10. The product inventory evaluation apparatus of claim 1, wherein the control circuit in determining from the one or more shadows of at least the portion of the one or more product support units whether the first product is present is further configured to compare a height of a product support unit to a determined height of one or more products on a first shelf and determine a fullness of the first shelf based on the comparison of the product support unit height and the determined height of the one or more products on the first shelf.

11. The product inventory evaluation apparatus of claim 10, wherein the determining the height of the one or more products based on a distance between representations, in a first shadow, of notches on the product support unit.

12. A method of evaluating inventory, comprising:
by a control circuit of an inventory system of a shopping facility:
receiving one or more images of a floor of the shopping facility upon which multiple product support units are positioned and configured to store multiple different products;
identifying, in each of the one or more images, one or more shadows of at least a portion of one or more product support units of the multiple product support units; and
determining, from the one or more shadows of at least the portion of the one or more product support units, whether a first product is present and stored relative to each of the one or more product support units.

13. The method of claim 12, wherein the determining from the one or more shadows of at least the portion of the one or more product support units whether the first product is present, comprises:
detecting a lack of a shadow relative to a first portion of a first shadow corresponding to a first shelf; and
determining based on the detected lack of the shadow, that a first portion of the first shelf is empty.

14. The method of claim 13, wherein the detecting the lack of the shadow comprises identifying a shadow of a grating of the first shelf at the first portion of the first shadow.

15. The method of claim 12, further comprising:
causing a first light source, positioned proximate a first shelf of the one or more of a first product support unit causing the one or more shadows, to be turned on and causing a second light source to be turned off, wherein the second light source is positioned proximate to the first shelf and is separated from the first light source by a distance; and
communicating an instruction to activate an image capturing unit to capture a first image of the one or more images while the first light source is on and the second light source is off.

16. The method of claim 12, wherein the determining from the one or more shadows of at least the portion of the one or more product support units whether the first product is present comprises:
comparing the one or more shadows in a first image comprising a shadow of at least a first shelf with a reference shadow of at least the first shelf; and
determining a quantity of the first product as a function of a difference between the shadow of the first shelf in the first image and the reference shadow of the first shelf.

17. The method of claim 12, further comprising:
evaluating a first shadow of the one or more shadows of one or more of the multiple product support units;
determining, as a function of the evaluation of the first shadow, a location of the first shadow within the shopping facility;
identifying each of one or more shelves causing the first shadow based on the determined location of the first shadow;
obtaining, as specified in an inventory database, an expected inventory quantity value of the first product that is expected to be supported by the identified one or more shelves; and
determining whether there is a difference between the expected inventory quantity value of the first product expected to be supported by the identified one or more shelves and a quantity of the first product, determined from the one or more shadows, that are stored relative to each of the one or more shelves.

18. The method of claim 12, further comprising
determining a gradient offset between a first image of the floor of the one or more images and a reference image of the floor at a location where the first image is captured; and
wherein the identifying the one or more shadows of at least the portion of the one or more product support units further comprises applying the gradient offset in distinguishing between the one or more shadows on the floor and the floor without a shadow.

19. The method of claim 12, further comprising:
identifying a difference between a determined quantity of the first product, determined based on the one or more shadows of at least the portion of the one or more product support units, relative to an expected inventory quantity value; and
communicating a request to a shopping facility worker to audit the first product when the difference is greater than a difference threshold.

20. A product inventory evaluation system, comprising:
multiple product support units;
at least one image capturing unit;
an inventory tracking unit coupled to the at least one image capturing unit and comprising:
a transceiver configured to couple with and receive communications from over a distributed network;
a control circuit coupled with the transceiver; and
a memory coupled to the control circuit and storing computer instructions that when executed by the control circuit cause the control circuit to:
receive one or more images of a floor of a shopping facility upon which the multiple product support units are positioned and configured to store multiple different products;
identify, in each of the one or more images, one or more shadows of at least a portion of one or more product support units of the multiple product support units; and
determine, from the one or more shadows of at least the portion of the one or more product support units, whether a first product is present and stored relative to each of the one or more product support units.

21. A product inventory evaluation system, comprising:
multiple product support units;
at least one image capturing unit;
an inventory tracking unit coupled to the at least one image capturing unit and comprising:
a transceiver configured to couple with and receive communications from over a distributed network;
a control circuit coupled with the transceiver; and
a memory coupled to the control circuit and storing computer instructions that when executed by the control circuit cause the control circuit to:
receive one or more images of a floor of a shopping facility upon which the multiple product support units are positioned and configured to store multiple different products;
determine a gradient offset between a first image of the floor of the one or more images and a reference image of the floor at a location where the first image is captured;
apply the gradient offset in distinguishing between one or more shadows on the floor and the floor without a shadow;
identify, in each of the one or more images, one or more distinguished shadows of at least a portion of one or more product support units of the multiple product support units;
determine, from the one or more shadows of at least the portion of the one or more product support units, whether a first product is present and stored relative to each of the one or more product support units;
identify a difference between a determined quantity of the first product, determined based on the one or more shadows of at least the portion of the one or more product support units, relative to an expected inventory quantity; and
communicate a request to a shopping facility worker to audit the first product when the difference is greater than a difference threshold.

22. A product inventory evaluation system, comprising:
a control circuit of an inventory system of a shopping facility, comprising:
means for receiving one or more images of a floor of the shopping facility upon which multiple product support units are positioned and configured to store multiple different products;
means for identifying, in each of the one or more images, one or more shadows of at least a portion of one or more product support units of the multiple product support units; and
means for determining, from the one or more shadows of at least the portion of the one or more product support units, whether a first product is present and stored relative to each of the one or more product support units.
